(19) United States
(12) Patent Application Publication
(10) Pub. No.: US 2008/0241475 A1
(43) Pub. Date: Oct. 2, 2008

(54) GRAPHITE-SILICON CARBIDE COMPOSITE AND MAKING METHOD

(76) Inventors: Hirofumi Fukuoka, Annaka-shi (JP); Susumu Ueno, Annaka-shi (JP); Mikio Aramata, Annaka-shi (JP); Toshio Okada, Annaka-shi (JP); Noriaki Hamaya, Echizen-shi (JP); Takao Maeda, Echizen-shi (JP)

Correspondence Address: BIRCH STEWART KOLASCH & BIRCH, PO BOX 747, FALLS CHURCH, VA, 22040-0747, US

(21) Appl. No.: 12/055,985

(22) Filed: Mar. 26, 2008

(30) Foreign Application Priority Data
Mar. 28, 2007 (JP) 2007-084385

(51) Int. Cl. B32B 5/16; B05D 3/02; B05D 1/06

(52) U.S. Cl. 428/149; 427/190

(57) ABSTRACT

A graphite-silicon carbide composite comprises a graphite substrate and a silicon carbide layer formed thereon and comprising silicon carbide particles in fused and contact bonded state. The composite has excellent oxidation resistance and finds a wide range of application as heat resistant material. The method of forming a silicon carbide layer on graphite surface is simple and consistent.

### CROSS-REFERENCE TO RELATED APPLICATION

This non-provisional application claims priority under 35 U.S.C. §119(a) on Patent Application No. 2007-084385 filed in Japan on Mar. 28, 2007, the entire contents of which are hereby incorporated by reference.

### TECHNICAL FIELD

This invention relates to graphite-silicon carbide composites which are applicable even in an oxidizing atmosphere as high-temperature structures, fixtures, semiconductor equipment members, liquid crystal equipment members, mechanical sliders and the like, and a method for preparing the same.

### BACKGROUND ART

Because of excellent high-temperature properties, mechanical strength and workability, graphite materials find use as a variety of high-temperature materials. However, graphite materials are less resistant to oxidation and thus limited to use in a non-oxidizing atmosphere. The high-temperature materials which can be used in an oxidizing atmosphere are oxide ceramics including silicon carbide, silicon nitride and alumina. However, these ceramics suffer from several problems including inefficient working, difficult size enlargement, and poor thermal shock resistance.

Then, for improved oxidation resistance, an attempt was made to produce a graphite-silicon carbide composite by coating the surface of graphite with a silicon carbide layer. Several methods are known for the preparation of graphite-silicon carbide composites. For instance, JP-B 61-11911 discloses a method for preparing a silicon carbide-graphite composite by providing a carbon substrate in which micro-pores having a specific diameter occupy a volume of at least 0.02 cm³/g and effecting conversion using SiO gas. JP-A 62-132787 discloses a method for preparing a silicon carbide-graphite composite by providing a porous silicon carbide sintered body having an open porosity of 5 to 55% and an average pore size of 1 to 100 μm and filling open pores with carbon. JP Patent 2620294 discloses a method for preparing a silicon carbide-graphite composite by infiltrating molten silicon into a porous graphite substrate and effecting reaction.

However, these prior art methods involve complicated steps and result in low yields of manufacture, which means that the resulting graphite-silicon carbide composites are expensive. Substantial variations of silicon carbide coating and inconsistent quality of products are also problems. These production methods are thus not regarded as industrially efficient.

### DISCLOSURE OF THE INVENTION

An object of the invention is to provide a graphite-silicon carbide composite which is resistant to a high-temperature oxidizing atmosphere, useful as heat resistant material, and minimized in the variation of quality, and a method for preparing the same.

The inventors have found that by thermally spraying metallic silicon having a selected particle size onto a surface of a graphite substrate and heat treating the coated substrate, a silicon carbide layer having a desired thickness with minimized variation can be readily formed on the graphite substrate surface, and that the resulting graphite-silicon carbide composite tolerates use in a high-temperature oxidizing atmosphere.

In one aspect, the invention provides a graphite-silicon carbide composite comprising a graphite substrate having a surface and a silicon carbide layer formed on the surface. The silicon carbide layer is composed of silicon carbide particles in fused and contact bonded state.

In preferred embodiments, the silicon carbide particles have an average particle size of 0.5 μm to 50 μm, and the silicon carbide layer has a thickness of 10 μm to 300 μm. Typically the graphite-silicon carbide composite has a gas permeability equal to or less than 1.0×10⁻² cm²/s.

In another aspect, the invention provides a method for preparing a graphite-silicon carbide composite comprising the steps of thermally spraying a metallic silicon powder onto a surface of a graphite substrate, and heat treating the sprayed substrate in a non-oxidizing atmosphere at a temperature of 1100° C. to 1700° C. for forming on the substrate surface a silicon carbide layer comprising silicon carbide particles in fused and contact bonded state. Preferably, the metallic silicon powder has an average particle size of 0.5 μm to 50 μm.

### BENEFITS OF THE INVENTION

The graphite-silicon carbide composite of the invention has excellent oxidation resistance and finds a wider range of various applications as heat resistant material. The method of forming a silicon carbide layer on graphite surface is simple and consistent enough to ensure production of graphite-silicon carbide composites with minimized variation in quality and to enable efficient manufacture on an industrial scale.

### DESCRIPTION OF THE PREFERRED EMBODIMENT

The graphite-silicon carbide composite of the invention comprises a graphite substrate and a silicon carbide layer formed thereon. The silicon carbide layer consists of silicon carbide particles in fused and contact bonded state. The “silicon carbide particles in fused and contact bonded state” means that silicon carbide in the fused state forms a junction or bond between graphite substrate and silicon carbide or between silicon carbides together by an impetus toward the graphite substrate in a perpendicular direction thereto. Specifically, silicon carbide takes an ellipsoidal shape and forms a junction or bond in surface contact rather than in point contact.

The graphite-silicon carbide composite is prepared by thermally spraying a metallic silicon powder onto a surface of a graphite substrate and heat treating the sprayed substrate in a non-oxidizing atmosphere at a temperature of 1100° C. to 1700° C.

The graphite substrate used herein is not particularly limited. A choice may be made among cold isostatic press (CIP) molded parts, extrusion molded parts and carbon/carbon (C/C) composites, depending on an intended application. Of these, C/C composites are advantageously used for high strength. The shape and size of graphite substrate are not particularly limited. It is understood that C/C composites are composite materials formed from carbon fibers and graphite particles and having high strength and brittleness. The mixing ratio of carbon fibers to graphite particles is generally in a range between 7/3 and 3/7.

Next, silicon powder is thermally sprayed on the graphite substrate. The spraying method is not particularly limited and includes plasma spraying, combustion flame spraying using acetylene, propane or kerosene as the fuel gas, and high-velocity flame spraying. Silicon powder is fed into a plasma flame or gas flame whereby silicon in semi-fused state is sprayed to the graphite substrate. Of these, the plasma spraying is advantageously used because a coating of better adhesion can be formed at higher temperature.

The silicon powder to be sprayed is not particularly limited. A choice may be made among silicon powders of the semiconductor, ceramic and chemical grades, depending on an intended application. Although the particle size of silicon powder is not particularly limited as well, an average particle size of 0.5 to 50 μm is desired, and more desirably 3 to 30 μm. A powder with an average particle size of less than 0.5 μm may be difficult to spray, with a uniform spray being not expectable. A powder with an average particle size of more than 50 μm can be sprayed, but may hinder its conversion into silicon carbide by heat treatment, resulting in a silicon carbide layer on the graphite substrate surface containing more unreacted silicon powder.

It is noted that the “average particle size” refers to a weight average value D₅₀ when the particle size distribution is determined by a laser diffraction technique, i.e., a particle size when the cumulative weight reaches 50% (also referred to as median particle size).

Particles of silicon carbide formed by spraying the silicon powder and subsequent heat treatment also have an average particle size of 0.5 to 50 μm, and more desirably 3 to 30 μm. The average particle size of silicon carbide particles is evaluated as a value corresponding to the average particle size of silicon powder.

The size of SiC particles may be measured by sedimentation, image analysis, laser diffraction or other techniques. Herein, a particle size as determined by the laser diffraction technique is used for quick measurement and high reproducibility.

Once the silicon powder is sprayed on the graphite substrate surface, the sprayed substrate is heat treated to form a silicon carbide layer on its surface. Heat treatment is at a temperature of 1100° C. to 1700° C. and preferably 1200° C. to 1500° C. A heat treatment temperature below 1100° C. achieves a low percent conversion of silicon powder to silicon carbide, resulting in a silicon carbide layer containing more unreacted silicon powder. If the heat treatment temperature exceeds 1700° C., which is far beyond the melting point of silicon powder, the sprayed silicon powder is thoroughly melted, resulting in a graphite-silicon carbide composite having a silicon carbide layer with noticeably varying thickness.

As long as the atmosphere where heat treatment is carried out is a non-oxidizing atmosphere, no other considerations are necessary. Heat treatment may be carried out in an inert gas such as Ar or He and under atmospheric or reduced pressure. The apparatus for carrying out heat treatment is not particularly limited as well, and a batch furnace, continuous tunnel furnace or the like may be used.

The sprayed coating of silicon powder preferably has a thickness of 10 to 300 μm, and more preferably 10 to 200 μm, although the thickness is not particularly limited. Correspondingly, the silicon carbide layer of the graphite-silicon carbide composite also preferably has a thickness of 10 to 300 μm, and more preferably 10 to 200 μm. If the thickness is less than 10 μm, the silicon carbide layer may have a lower gas permeability and not tolerate long-term service in a high-temperature oxidizing atmosphere. Inversely, if the thickness is more than 300 μm, no improvement in gas permeability is observed and an increased spray cost is the only result. Since the thickness of silicon carbide layer can be controlled by the thickness of a coating of silicon powder sprayed, a predetermined thickness is readily achievable.

Preferably, the graphite-silicon carbide composite has a gas permeability equal to or less than 1.0×10⁻² cm²/s and more preferably equal to or less than 1.0×10⁻³ cm²/s. If the gas permeability is more than 1.0×10⁻² cm²/s, oxygen in the ambient atmosphere can reach the graphite matrix to detract from the oxidation resistance of the composite. Since the gas permeability can be controlled by the thickness of silicon carbide layer, a gas permeability of 1.0×10⁻² cm²/s or less is achievable by setting the thickness of silicon carbide layer to 10 μm or greater.

It is noted that the gas permeability is determined according to Darcy equation by measuring a volume of gas flow through a specimen when a pressure difference ΔP is established across the specimen.

K=QL/ΔPA

K: gas permeability (cm²/s)

Q: volume of gas flow (Pa-cm³/s)

ΔP: pressure difference across specimen (Pa)

L: specimen thickness (cm)

A: gas permeation area (cm²)

### EXAMPLE

Examples of the invention are given below by way of illustration and not by way of limitation.

### Example 1

On entire surfaces of a C/C composite plate of 100 mm×100 mm×5 mm (thick), a metallic silicon powder having an average particle size of 20 μm was plasma sprayed to form a silicon powder coating of 50 μm thick. The coated plate was then placed in a batch furnace where it was heat treated in a reduced pressure and at 1450° C. for 5 hours.

For the product, a cross section of the substrate was observed and the surface layer was analyzed by X-ray diffraction microscopy. It was a green graphite-silicon carbide composite in which particulate silicon carbide having an average particle size of 20 μm had been fused and contact bonded. The composite had a gas permeability of 1.0×10⁻⁵ cm²/s.

The graphite-silicon carbide composite was evaluated for oxidation resistance. It was held in air at 800° C. for 3 hours, and then cooled down. The weight was measured to find a weight loss of −0.1 wt %. A weight change of substantially zero proved it to be a fully oxidation resistant material.

### Comparative Example 1

A C/C composite plate without a silicon carbide layer was subjected to the oxidation resistance test as in Example 1. It is noted that the C/C composite plate had a gas permeability of 5.0×10⁻¹ cm²/s. A weight loss on heating of −88 wt % was found, indicating inferior heat resistance to Example 1.

Japanese Patent Application No. 2007-084385 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A graphite-silicon carbide composite comprising a graphite substrate having a surface and a silicon carbide layer formed on the surface and comprising silicon carbide particles in fused and contact bonded state.

2. The graphite-silicon carbide composite of claim 1 wherein the silicon carbide particles have an average particle size of 0.5 μm to 50 μm.

3. The graphite-silicon carbide composite of claim 1 wherein the silicon carbide layer has a thickness of 10 μm to 300 μm.

4. The graphite-silicon carbide composite of claim 1, having a gas permeability equal to or less than 1.0×10⁻² cm²/s.

5. A method for preparing a graphite-silicon carbide composite comprising the steps of:
thermally spraying a metallic silicon powder onto a surface of a graphite substrate, and
heat treating the sprayed substrate in a non-oxidizing atmosphere at a temperature of 1100° C. to 1700° C. for forming on the substrate surface a silicon carbide layer comprising silicon carbide particles in fused and contact bonded state.

6. The method of claim 5 wherein the metallic silicon powder has an average particle size of 0.5 μm to 50 μm.
